(19) United States
(12) Patent Application Publication
(10) Pub. No.: US 2024/0183254 A1
(43) Pub. Date: Jun. 6, 2024

(54) DIAMOND-LIKE CARBON COATING FOR MOTORS OF ELECTRIC SUBMERSIBLE PUMPS AND RELATED METHODS

(71) Applicant: Saudi Arabian Oil Company, Dhahran (SA)

(72) Inventors: Qiwei Wang, Dhahran (SA); Rui F. Pessoa Rodrigues, Dammam (SA)

(21) Appl. No.: 18/076,118

(22) Filed: Dec. 6, 2022

(51) Int. Cl. E21B 43/12; C23C 30/00; E21B 41/02

(52) U.S. Cl. CPC E21B 43/128; C23C 30/00; E21B 41/02

(57) ABSTRACT

The disclosure relates to systems and methods that include coating a motor of an ESP with a DLC coating. The DLC coating includes a dopant and is hydrophobic. The coating can reduce (e.g., prevent) scale formation on the surface of the motor and/or reduce an amount of scale inhibitor chemical used to reduce scale.

### FIELD

The disclosure relates to systems and methods that include coating a motor of an electric submersible pump (ESP) with a diamond-like carbon (DLC) coating. The DLC coating includes a dopant and is hydrophobic. The coating can reduce (e.g., prevent) scale formation on the surface of the motor and/or reduce an amount of scale inhibitor chemical used to reduce scale.

### BACKGROUND

An ESP can be used to pump produced fluids from a wellbore of a well (e.g., an oil well, a gas well) to the earth's surface. In the wellbore, scale deposits (e.g., deposits of inorganic scale such as calcium carbonate and calcium sulfate) can form on the motor of the ESP due to wellbore conditions (e.g., relatively high concentrations of scale forming chemicals in produced fluids). Scale inhibitor chemicals can be used to reduce scale formation but their use may be limited due to harsh environments, changing fluid properties and/or limited space availability for injection.

### SUMMARY

The disclosure relates to systems and methods that include coating a motor of an ESP with a DLC coating. The DLC coating includes a dopant and is hydrophobic. The coating can reduce (e.g., prevent) scale formation on the surface of the motor and/or reduce an amount of scale inhibitor chemical used to reduce scale.

An ESP motor can generate a relatively large amount of heat. This can accelerate the scale formation on the ESP motor because the solubility of scales (e.g., calcium carbonate, calcium sulfate) decreases with increasing temperature and thus the scaling rate increases with increasing temperature. The systems and methods of the disclosure can reduce (e.g., prevent) scale formation on an ESP motor. This can reduce (e.g., prevent) premature failure (e.g., due to scale deposition on the motor surface causing overheating, stuck shafts and/or broken shafts) of an ESP and/or improve performance of an ESP. For example, the systems and methods of the disclosure can reduce (e.g., prevent) overheating caused by scale formations. Without wishing to be bound by theory, it is believed that the run life of the motor depends on the motor temperature and relatively high motor temperatures can cause the electrical insulation to age and breakdown. Scale may act as a thermal insulation layer with thicker layers of scale resulting in increased thermal insulation. The systems and methods can therefore reduce (e.g., prevent) overheating associated with scale formation. Additionally, the systems and methods of the disclosure can increase the ESP efficiency thereby reducing carbon emissions. The resistance/impedance of the motor windings material (e.g., copper) can increase with increasing temperature. At relatively high motor operating temperatures resulting from scale deposition, the motor may consume more electric power, thereby reducing its efficiency, relative to certain other motors that do not include scale deposition. The DLC coating can reduce (e.g., prevent) scale formation, allowing the motor to run cooler and reducing electrical power consumption relative to certain other motors with scale deposition.

In general, the DLC coating of the disclosure is relatively chemically inert, has relatively high erosion/corrosion resistance, has relatively high thermal conductivity (e.g., at least 1100 W/mk) and can form a relatively strong adhesion to a metal substrate. The DLC coating can be chemically inert to acid gases (e.g., carbon dioxide, hydrogen sulfide) and/or other dissolved components in produced fluids (e.g., a produced hydrocarbon, produced water), even at relatively high temperatures. The systems and methods of the disclosure can be used in relatively harsh environments with relatively high temperatures, relatively high pressures, abrasives and/or acid gas (e.g., carbon dioxide, hydrogen sulfide), such as may be present in the wellbore of an oil well or a gas well. The DLC coatings of the disclosure can have improved resistance to scale deposits, improved mechanical properties, improved physical properties, improved performance, improved adhesion to substrates, improved hardness, improved wear resistance and/or improved erosion/corrosion resistance relative to certain other coatings such as polymer-based hydrophobic coatings, ceramics, epoxy-based coatings and Teflon.

The systems and methods of the disclosure can reduce capital expenditures and operating expenses related to ESP operation, maintenance, repair and/or replacement as well as reduce costs and reduce (e.g., prevent) losses associated with workovers, deferred production and/or locked potential due to ESP damage and failure, relative to certain other systems that lack the coating of the present disclosure.

The system and methods of the disclosure can reduce scale formation on the surfaces of an ESP motor, compared to certain other systems in which the ESP lacks the coating of the disclosure. Without wishing to be bound by theory, it is believed that the nucleation and crystal growth on the motor surface can be reduced relative to certain other systems as methods, which can reduce the amount of scale particles to be carried to additional components.

The systems and methods of the disclosure can reduce or eliminate scale inhibitor chemical consumption, reduce the frequency of scale inhibitor chemical treatments, and/or allow the scale inhibitor chemical to more effectively prevent scale deposition on the motor at lower concentrations, thus increasing the scale inhibitor chemical treatment lifetime, relative to certain other systems and methods that lack the coating of the present disclosure. The coatings of the disclosure can have relatively low cost (e.g., compared to the cost of scale inhibitor chemicals). The systems and methods can be employed in offshore applications where a footprint for scale inhibitor chemical treatment is unfeasible. Safety concerns and costs related to the use of scale inhibitor chemicals can also be reduced or eliminated relative to certain other systems and methods that lack the coating of the disclosure.

In a first aspect, the disclosure provides a system including a motor including a housing that houses a motor stator and a diamond-like carbon coating supported by the housing. The diamond-like carbon coating includes a dopant.

In some embodiments, the motor further includes at least one member selected from the group consisting of a motor head and a motor base, and the member includes the diamond-like carbon coating.

In some embodiments, the dopant includes fluorine, oxygen, nitrogen and/or silicon.

In some embodiments, the diamond-like carbon coating includes from 5 atomic percentage (at. %) to 20 at. % of the dopant.

In some embodiments, a contact angle for the diamond-like carbon coating is from 90° to 180°.

In some embodiments, a thickness of the diamond-like carbon coating is from 0.5 μm to 50 μm.

In some embodiments, the diamond-like carbon coating has a thermal conductivity of from 400 Wm⁻¹K⁻¹ to 1500 Wm⁻¹K⁻¹.

In some embodiments, the diamond-like carbon coating has a hardness of from 8 GPa to 25 GPa.

In some embodiments, the system further includes a pump, and the motor is configured to operate the pump.

In some embodiments, the system further includes a borehole of a well and the motor and the pump are disposed in the borehole.

In some embodiments, the pump does not include the diamond-like carbon coating.

In some embodiments, the system further includes a seal between the motor and the pump.

In some embodiments, the system further includes a produced fluid including a produced hydrocarbon and the produced hydrocarbon defines a film between produced water and the diamond-like carbon coating.

In some embodiments, the pump does not include the diamond-like carbon coating.

In some embodiments, the system further includes a borehole of a well, and the motor and the pump are disposed in the borehole.

In some embodiments, the motor further includes at least one member selected from the group consisting of a motor head and a motor base, and the member includes the diamond-like carbon coating.

In some embodiments, the motor is in electrical communication with a power source.

In a second aspect, the disclosure provides a method, including using a pump to pump a liquid from a subterranean formation using a well including a wellbore. The pump is in the wellbore, the pump is powered by a motor that supports a diamond-like carbon coating including a dopant, and the motor is in the wellbore.

In some embodiments, the method further includes disposing a scale inhibitor into the subterranean formation.

In some embodiments, a lifetime for scale inhibitor is at least 12 months.

### BRIEF DESCRIPTION OF THE FIGURES

FIG. 1 depicts a schematic of a system.

FIG. 2A depicts a schematic of a motor.

FIG. 2B depicts a schematic of components of the system of FIG. 2A.

FIG. 3A depicts a schematic of a system.

FIG. 3B depicts a plot of flow rate of the system of FIG. 3A as a function of distance from the surface of a motor.

FIG. 4A depicts a schematic of a system.

FIG. 4B depicts a plot of flow rate of the system of FIG. 4A as a function of distance from the surface of a motor.

FIG. 5 depicts a plot of inhibitor concentration as a function of time.

### DETAILED DESCRIPTION

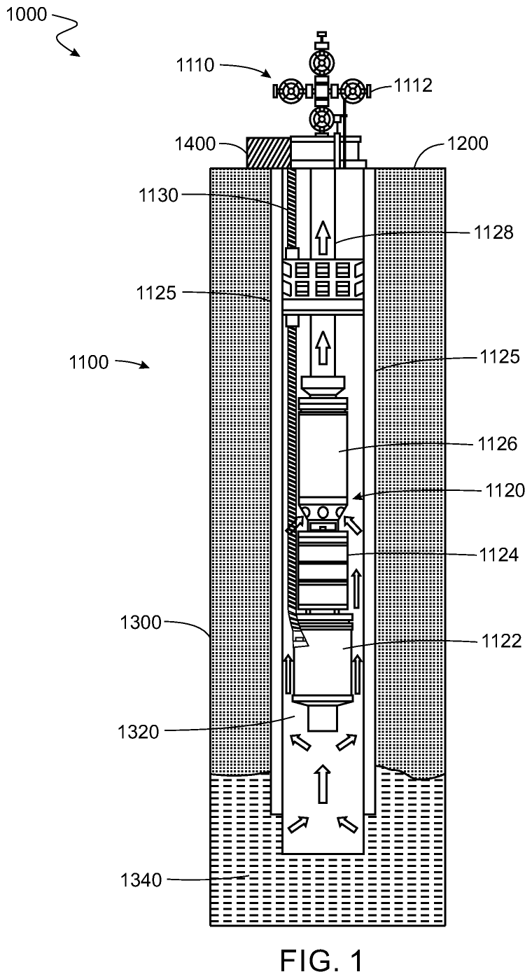

FIG. 1 depicts a system 1000 that includes a hydrocarbon-producing well 1100 with a portion 1110 above the earth's surface 1200 and a portion 1120 below the earth's surface 1200. The portion 1110 includes a wellhead 1112. The portion 1120 is disposed in a wellbore 1320 in an underground formation 1300 and includes well casings 1125, an ESP that includes a motor 1122, a seal 1124 connected to the motor 1122, and a pump 1126 connected to the seal 1124, and tubing 1128 connected to the pump 1126. The wellbore 1320 is in fluid communication with a reservoir 1340 in the underground formation 1300. The motor 1122 is configured to operate the pump 1126, which lifts a produced fluid (e.g., a produced hydrocarbon, produced water) from the reservoir 1340 through the tubing 1128 to the wellhead 1112. The seal 1124 equalizes the internal pressure of the motor 1122 with that of the well 1100, provides a reservoir of high dielectric oil to accommodate the thermal expansion and contraction of the motor oil during the normal cycles of operation and shutdown and transmits mechanical power between the motor 1122 and shafts of the pump 1126. A power cable 1130, connected to a power source 1400, provides power to the motor 1122.

The motor 1122 includes a DLC coating. The DLC coating includes an amorphous carbon structure which is a mixture of sp³ bonded diamond and graphitic sp² carbon, and contains hydrogen atoms. The DLC coating further includes one or more dopants doped into the amorphous carbon structure. In some embodiments, a dopant includes fluorine, oxygen, nitrogen and/or silicon. In general, a dopant alters the surface wettability of the DLC coating so that the dopant-containing DLC coating is hydrophobic, and, in some cases, superhydrophobic. The hydrophobic/superhydrophobic surface of the DLC can reduce (e.g., prevent) scale formation relative to hydrophilic surfaces (see discussion below). Without wishing to be bound by theory, it is believed that a fluorinated DLC coating can have a relatively low surface energy and consequently reduce scale adhesion.

In certain embodiments, the DLC coating includes at least 5 (e.g., at least 10, at least 15) atomic percent (at. %) of the dopant(s) and/or at most 20 (e.g., at most 15, at most 10) at. % of the dopant(s).

In certain embodiments, the DLC coating has a contact angle of at least 90° (e.g., at least 100°, at least 110°, at least 120°, at least 130°, at least 140°, at least 150°, at least 160°, at least) 170° and/or at most 180° (e.g., at most 170°, at most 160°, at most 150°, at most 140°, at most 130°, at most 120°, at most 110°, at most 100°).

In certain embodiments, the DLC coating has a thermal conductivity of at least 400 (e.g., at least 500, at least 600, at least 700, at least 800, at least 900, at least 1000, at least 1100, at least 1200, at least 1300, at least 1400) Wm⁻¹K⁻¹ and/or at most 1500 (e.g., at most 1400, at most 1300, at most 1200, at most 1100, at most 1000, at most 900, at most 800, at most 700, at most 600, at most 500) Wm⁻¹K⁻¹.

In some embodiments, the DLC coating has a hardness of at least 8 (e.g., at least 9, at least 10, at least 11, at least 12, at least 13, at least 14, at least 15, at least 16, at least 17, at least 18, at least 19, at least 20, at least 21, at least 22, at least 23, at least 24) GPa and/or at most 25 (e.g., at most 24, at most 23, at most 22, at most 21, at most 20, at most 19, at most 18, at most 17, at most 16, at most 15, at most 14, at most 13, at most 12, at most 11, at most 10, at most 9) GPa.

The DLC coating can be coated on the motor 1122 using any suitable method, such as magnetron sputtering, chemical vapor deposition (CVD), pulsed laser deposition (PLD), direct ion beam, or ion beam assisted cathodic arc deposition. The topography of the DLC coating can be controlled to improve the anti-scaling characteristics. Without wishing to be bound by theory, it is believed that smoother surfaces have less tendency for scale deposition.

In some embodiments, the thickness of the DLC coating is at least 0.5 (e.g., at least 1, at least 2, at least 3, at least 4, at least 5, at least 6, at least 7, at least 8, at least 9, at least 10, at least 15, at least 20, at least 25, at least 30, at least 35, at least 40, at least 45) μm and/or at most 50 (e.g., at most 45, at most 40, at most 35, at most 30, at most 25, at most 20, at most 15, at most 10, at most 9, at most 8, at most 7, at most 6, at most 5, at most 4, at most 3, at most 2, at most 1) μm.

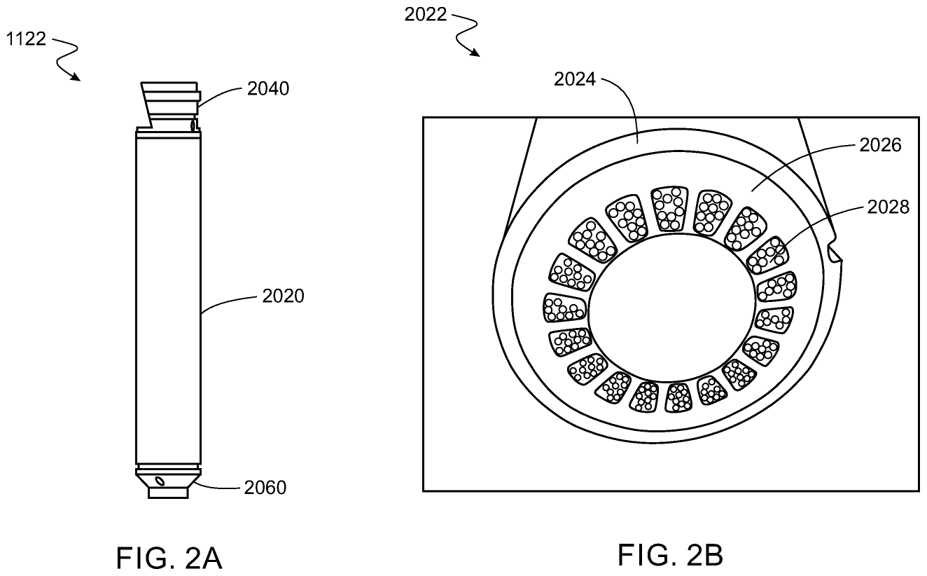

FIG. 2A depicts a schematic of the motor 1122. The motor includes a motor stator 2020, a motor head 2040 and a motor base 2060.

FIG. 2B depicts a cross section 2022 of the motor stator 2020. The cross section 2022 of the motor stator 2020 includes a housing 2024, laminations 2026 and windings 2028.

In general, at least one of the components of the motor 1122 external surface (including the motor stator 2020, the motor head 2040 and the motor base 2060), is exposed to the produced fluids in the wellbore 1320 and at risk of scale formation. Accordingly, one or more of these components bears the DLC coating. In some embodiments, the motor stator 2020 includes the DLC coating. In some embodiments, the housing 2024 of the motor stator 2020 supports the DLC coating. In some embodiments, the motor stator 2020, the motor head 2040 and/or the motor base 2060 include the DLC coating. Without wishing to be bound by theory, it is believed that because the motor stator 2020 is longer than the motor head 2040 and the motor base 2060, a larger benefit can be achieved by coating the motor stator 2020 relative to coating the motor head 2040 and/or the motor base 2060. However, because the motor head 2040 and the motor base 2060 are also exposed to produced fluids, a benefit can be realized by coating the motor head 2040 and/or the motor base 2060 in addition to the motor stator 2020.

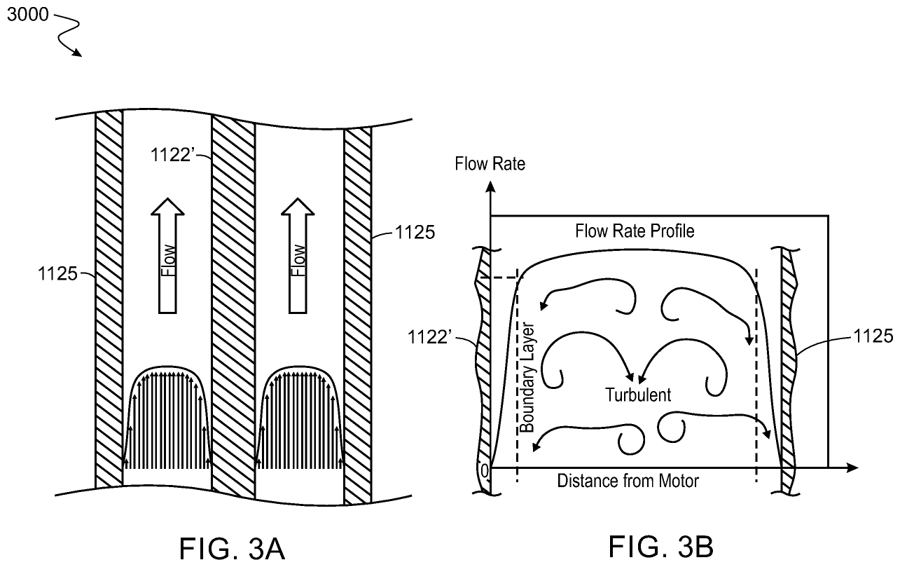

FIG. 3A depicts a schematic of a system 3000 that includes an annular space between a motor 1122′ and well casings 1125. FIG. 3A also shows illustrative flow rate profiles for a produced fluid located between the motor 1122′ and the well casings 1125. The motor 1122′ does not include the DLC coating of the disclosure and instead has a surface composed of a relatively hydrophilic material (e.g., carbon steel, stainless steel, Monel alloy, epoxy). The flow rate of the produced fluid is relatively low at the surface of the motor 1122′ and the well casings 1125 and increases as the distance from the motor 1122′ and the well casings 1125 increases, reaching a maximum near the center of the space between the motor 1122′ and the well casings 1125.

FIG. 3B is an illustrative plot of the flow rate profile for the right side of portion of the system 3000. The x-axis represents the distance from the motor 1122′ and the y-axis represents the flow rate. Illustrative boundary layers of the produced fluid correspond to fluid adjacent the surface of the well casings 1125 and the motor 1122′. The boundary layers are depicted by dashed lines. An illustrative bulk fluid corresponds to the produced fluid between the boundary layers. Compared to the produced fluid within the boundary layers, the bulk fluid has a relatively high flow rate. In addition, compared with the produced fluid within the boundary layers, the bulk fluid exhibits more turbulent flow. Without wishing to be bound by theory, it is believed that due to the relatively low flow rate, the produced fluid in the boundary layers is heated to a higher temperature relative to the bulk fluid (e.g., up to 50° F. higher than the bulk fluid). It is believed that the relatively hot produced fluid in the boundary layers can act as an incubator for the formation of scale particles by promoting nucleation and crystal growth.

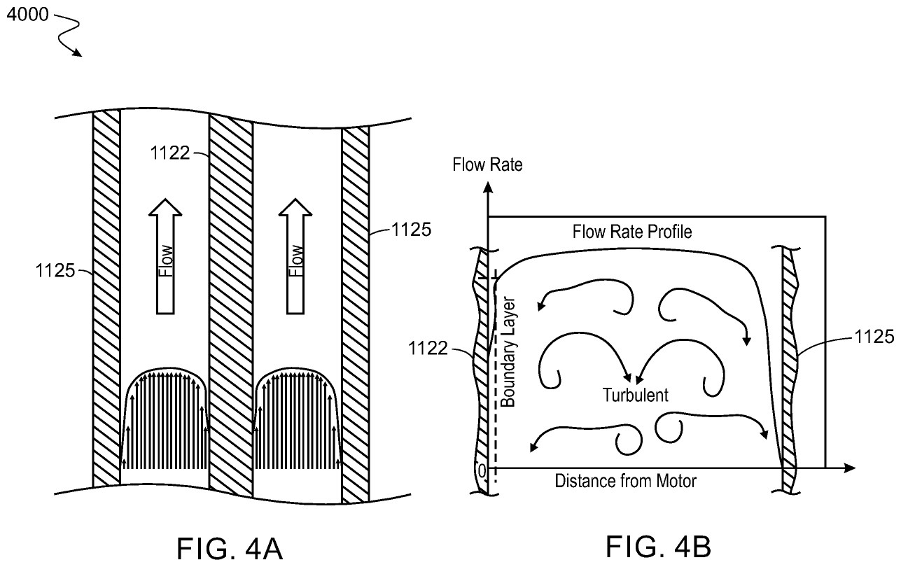

FIG. 4A depicts a schematic 4000 of a flow rate profile in an annular space between a motor 1122 and well casings 1125. The motor 1122 includes the DLC coating of the disclosure. The flow rate adjacent the surface of the motor 1122 is not reduced to the same extent as the flow rate adjacent the surface of the motor 1122′.

FIG. 4B is an illustrative plot of the flow rate profile for the right side portion of the schematic 4000. The x-axis represents the distance from the motor 1122 and the y-axis represents the flow rate of the produced fluid. The flow rate profile of FIG. 4B is different from the flow rate profile of FIG. 3B because the DLC coating of the disclosure reduces the thickness of the boundary layer of the produced fluid adjacent the surface of the motor 1122, relative to the motor 1122′. Similar to FIG. 3B, in FIG. 4B, the produced fluid in the bulk fluid has a relatively high flow rate and exhibits relatively turbulent flow compared to the produced fluid present in the boundary layers. However, the boundary layer adjacent to the surface of the motor 1122 (FIG. 4B) is thinner than the boundary layer adjacent to the surface of the motor 1122′ (FIG. 3B). Thus, there is less relatively slow moving fluid adjacent the surface of the motor 1122 compared to the amount of relatively slow moving fluid adjacent the surface of the motor 1122′. FIG. 4A shows that, compared to the situation depicted in FIG. 3A, the effect of the relatively hydrophobic/superhydrophobic surface of the motor 1122 is to repel more water from the surface of the motor 1122, resulting in a relatively thin boundary layer adjacent the surface of the motor 1122 and an increased flow rate of the produced fluid adjacent the surface of the motor 1122.

Without wishing to be bound by theory, it is believed that such a decrease in boundary layer thickness and increase in produced fluid flow rate reduces the residence time of the produced fluid in the boundary layer. It is believed that this results in a corresponding reduction in the amount of time that components in the produced water have to form/deposit scale on the surface of the motor 1122. If the residence time of the produced fluid in the boundary layer is less than the nucleation induction time, scale particles will not form. If the residence time is longer than the nucleation induction time, then the nucleation process can be delayed relative to the situation with the motor 1122′ because there is less time for nucleation and scale formation near the surface of the motor 1122 relative to the motor 1122′. Additionally, the relatively fast produced fluid flow rate adjacent the surface of the motor 1122 means that more scale particles formed in the boundary layer can be swept away from the surface of the motor 1122 compared to relatively slow fluid flow rate adjacent the surface of the motor 1122′. Furthermore, the hydrophobic/superhydrophobic surface of the motor 1122 can reduce the temperature rise of produced water in the boundary layer adjacent the surface of the motor 1122, thereby reducing the scaling driving force and scaling rate relative to the motor 1122′. Increasing the fluid speed and turbulence can increase the efficiency of the convective cooling process between the motor and the fluid.

In some embodiments, the produced fluid contains produced water and a produced hydrocarbon. In general, the produced water contains a relatively high concentration of scale forming ions compared to the produced hydrocarbon. Without wishing to be bound by theory, it is believed that, in some embodiments in which the produced fluid contains a produced hydrocarbon and produced water, the produced hydrocarbon can form a thin-layer film between the hydrophobic/superhydrophobic surface of the motor 1122 and the produced water. This thin-layer film can contain a relatively low concentration of scale forming ions. At the same time, the thin-layer film can reduce (e.g., prevent) direct contact of the surface of the motor 1122′ with the relatively high concentration of scaling ions present in the produced water. This can reduce (e.g., prevent) the deposition of inorganic scale formed from the produced water on the motor 1122 relative to the motor 1122′.

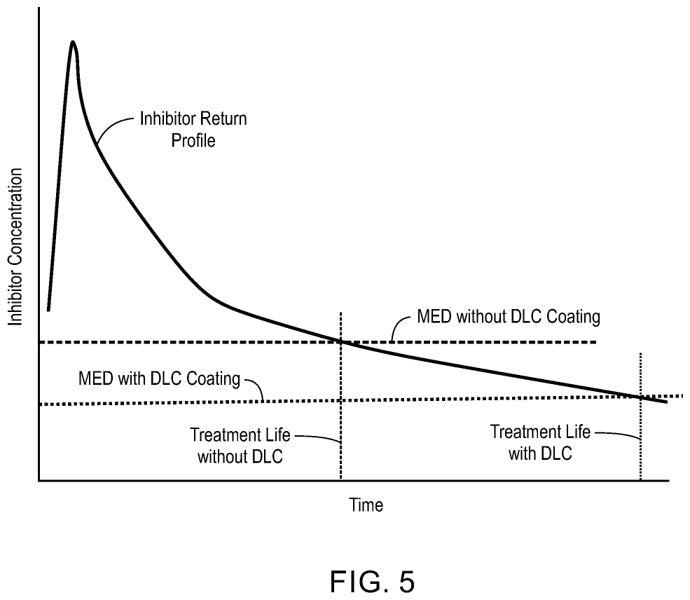

FIG. 5 shows an illustrative graph of the concentration of scale inhibitor in the produced water over time. The scale inhibitor may be deployed, for example, by squeeze treatment. After the inhibitor is deployed, the inhibitor concentration in the produced water decreases gradually as it is consumed and eventually falls below the minimum effective dosage (MED). Below the MED, scale formation can occur. FIG. 5 shows that, relative to a substantially similar system in which the motor lacks the DLC coating of the disclosure, an ESP motor with the DLC coating according to the disclosure has a lower MED, which increases the scale inhibitor treatment lifetime.

In some embodiments, the DLC coating of the disclosure on an ESP motor of a system extends the lifetime of the scale inhibitor chemical treatment. In some embodiments, the inhibitor treatment life is at least 6 (e.g., at least 7, at least 8, at least 9, at least 10, at least 11) months and/or at most 12 (e.g., at most 11, at most 10, at most 9, at most 8, at most 7) months in a system which the ESP motor lacks the DLC coating of the disclosure. In some embodiments, the inhibitor treatment life is at least 12 (e.g., at least 13, at least 14, at least 15, at least 16, at least 17, at least 18, at least 19, at least 20, at least 21, at least 22, at least 23, at least 24) months in the presence of the DLC coating of the disclosure.

Scale inhibitors include, for example, organic phosphates and small acrylate based polymers (typically with molecular weight≤5,000). Generally, increasing the temperature decreases the efficiency of a scale inhibitor treatment.

### Other Embodiments

While certain embodiments have been disclosed above, the disclosure is not limited to such embodiments.

As an example, while embodiments have been disclosed that include reducing (e.g., preventing) the formation of scale, the disclosure is not limited to such embodiments. In some embodiments, the systems and methods of the disclosure can reduce (e.g., prevent) the formation of asphaltene and/or wax deposits on the surface of the motor of an electric submersible pump.

As another example, while embodiments have been disclosed that include the components of the system 1000, the disclosure is not limited to such embodiments. In some embodiments, compared to the system 1000, the system can include one or more additional components, such as a packer, injection lines, and/or a wellhead penetrator. In some embodiments, the system does not include each component depicted in FIG. 1. Further, the arrangement of the components in a given system can be varied as appropriate.

What is claimed:

1. A system comprising:
a motor comprising a housing that houses a motor stator; and
a diamond-like carbon coating supported by the housing,
wherein the diamond-like carbon coating comprises a dopant.

2. The system of claim 1, wherein the motor further comprises at least one member selected from the group consisting of a motor head and a motor base, and the member comprises the diamond-like carbon coating.

3. The system of claim 1, wherein the dopant comprises at least one member selected from the group consisting of fluorine, oxygen, nitrogen and silicon.

4. The system of claim 1, wherein the diamond-like carbon coating comprises from 5 atomic percentage (at. %) to 20 at. % of the dopant.

5. The system of claim 1, wherein a contact angle for the diamond-like carbon coating is from 90° to 180°.

6. The system of claim 1, wherein a thickness of the diamond-like carbon coating is from 0.5 μm to 50 μm.

7. The system of claim 1, wherein the diamond-like carbon coating has a thermal conductivity of from 400 Wm⁻¹K⁻¹ to 1500 Wm⁻¹K⁻¹.

8. The system of claim 1, wherein the diamond-like carbon coating has a hardness of from 8 GPa to 25 GPa.

9. The system of claim 1, further comprising a pump, wherein the motor is configured to operate the pump.

10. The system of claim 9, further comprising a borehole of a well, wherein the motor and the pump are disposed in the borehole.

11. The system of claim 10, wherein the pump does not include the diamond-like carbon coating.

12. The system of claim 10, further comprising a seal between the motor and the pump.

13. The system of claim 12, further comprising a produced fluid comprising a produced hydrocarbon, wherein the produced hydrocarbon defines a film between produced water and the diamond-like carbon coating.

14. The system of claim 9, wherein the pump does not include the diamond-like carbon coating.

15. The system of claim 14, further comprising a borehole of a well, wherein the motor and the pump are disposed in the borehole.

16. The system of claim 14, wherein the motor further comprises at least one member selected from the group consisting of a motor head and a motor base, and the member comprises the diamond-like carbon coating.

17. The system of claim 1, wherein the motor is in electrical communication with a power source.

18. A method, comprising:
using a pump to pump a liquid from a subterranean formation using a well comprising a wellbore,
wherein:
the pump is in the wellbore,
the pump is powered by a motor that supports a diamond-like carbon coating comprising a dopant; and
the motor is in the wellbore.

19. The method of claim 18, further comprising disposing a scale inhibitor into the subterranean formation.

20. The method of claim 19, wherein a lifetime for scale inhibitor is at least 12 months.
